(19) United States
(12) Patent Application Publication
(10) Pub. No.: US 2012/0005720 A1
(43) Pub. Date: Jan. 5, 2012

(54) Categorization Of Privacy Data And Data Flow Detection With Rules Engine To Detect Privacy Breaches

(75) Inventors: Mark Alexander McGloin, Killiney (IE); Olgierd Stanislaw Pieczul, Dublin (IE); Mary Ellen Zurko, Groton, MA (US)

(73) Assignee: International Business Machines Corporation, Armonk, NY (US)

(21) Appl. No.: 12/828,988

(22) Filed: Jul. 1, 2010

(51) Int. Cl. G06F 21/00

(52) U.S. Cl. 726/1

(57) ABSTRACT

A runtime approach receives a request from a target location. Data elements are received from a data store. Privacy data type categories corresponding to retrieved data elements are identified. Data flow category is identified based on the target location. Privacy actions are performed modifying some data elements based on the identified privacy data type categories and the data flow category so that the modified data elements comply with one or more data privacy rules pertaining to the target location. A design-time approach retrieves data types included in a software application data design. Privacy categories are selected that correspond to the retrieved data types. Flow categorization data is retrieved that correspond to software application processes. Privacy categories and flow categorization data are compared to privacy rules. A user is informed if privacy rules are violated to facilitate software application modification in order to comply with the privacy rules.

### BACKGROUND

With the increased globalization of companies and tendency for collaboration across different organizations and geographically-bound jurisdictions, privacy issues have become a concern. This is particularly true in large organizations spanning many countries or jurisdictions where the transfer of different types of data may breach local laws depending on the type of data being transmitted. In addition social networking and collaboration software, often provided by “Software as a Service” (SaaS) providers, are increasingly used in businesses and present challenging privacy issues that may not have been present with older communication mechanisms and on-premises software applications. Application owners may need to implement features to ensure different privacy laws are not breached. However, using current technologies and approaches, implementing these features can be error prone as different laws are misinterpreted or ignored. This challenge is exacerbated by software application owners knowledge and focus being on local laws despite the fact that these software applications are deployed and used globally, thus subjecting the software application to laws in widespread, and often unfamiliar, jurisdictions. In addition, for SaaS application users, the onus is often on each organization using the SaaS application to ensure that employees' use of the software do not breach such privacy laws.

### SUMMARY

A runtime approach is provided that receives, at a source location, a request from a requestor, while the requestor is at a target location. Data elements responsive to the request are received from a data store. One or more privacy data type categories are identified that each correspond to one or more of the retrieved data elements. A data flow category is also identified with the data flow category being based on the target location. Privacy actions are then performed that modify some of the data elements based on the identified privacy data type categories and the data flow category. These data modifications are performed so that the modified data elements comply with one or more data privacy rules pertaining to the target location.

In addition, a design-time approach is provided that retrieves data types that have been included in a data design of a software application. Privacy categories are selected with each of the selected privacy categories corresponding to one or more of the retrieved data types from the software application. Flow categorization data is retrieved that corresponds to one or more processes included in the software application. The selected privacy categories and the retrieved flow categorization data are compared to privacy rules. As a result, a user, such as a system designer, is informed when the comparison reveals that one or more of the privacy rules is violated. This information facilitates modification of the software application in order to comply with the privacy rules.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 is a network diagram of various types of data processing systems connected via a computer network;

FIG. 3 is a diagram showing one implementation of privacy rules engines in order to comply with applicable privacy rules;

FIG. 4 is a diagram showing high level processes employed to categorize privacy data and data flows in order to detect privacy issues using a rules engine;

FIG. 5 is a high level flowchart showing processes performed and data gathered in order to execute the privacy rules engine;

FIG. 6 is an exemplary flowchart diagram showing the static (design time) categorization of privacy data types;

FIG. 7 is an exemplary flowchart diagram showing the static (design time) categorization of privacy data flows;

FIG. 8 is an exemplary flowchart diagram showing steps taken during runtime processing;

FIG. 9 is an exemplary flowchart diagram showing the dynamic (runtime) categorization of privacy data types;

FIG. 10 is an exemplary flowchart diagram showing the dynamic (runtime) categorization of privacy data flows; and

FIG. 11 is an exemplary flowchart diagram execution of the privacy rules engine to produce privacy compliant data.

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention. Instead, the following is intended to provide a detailed description of an example of the invention and should not be taken to be limiting of the invention itself. Rather, any number of variations may fall within the scope of the invention, which is defined by the claims that follow the description.

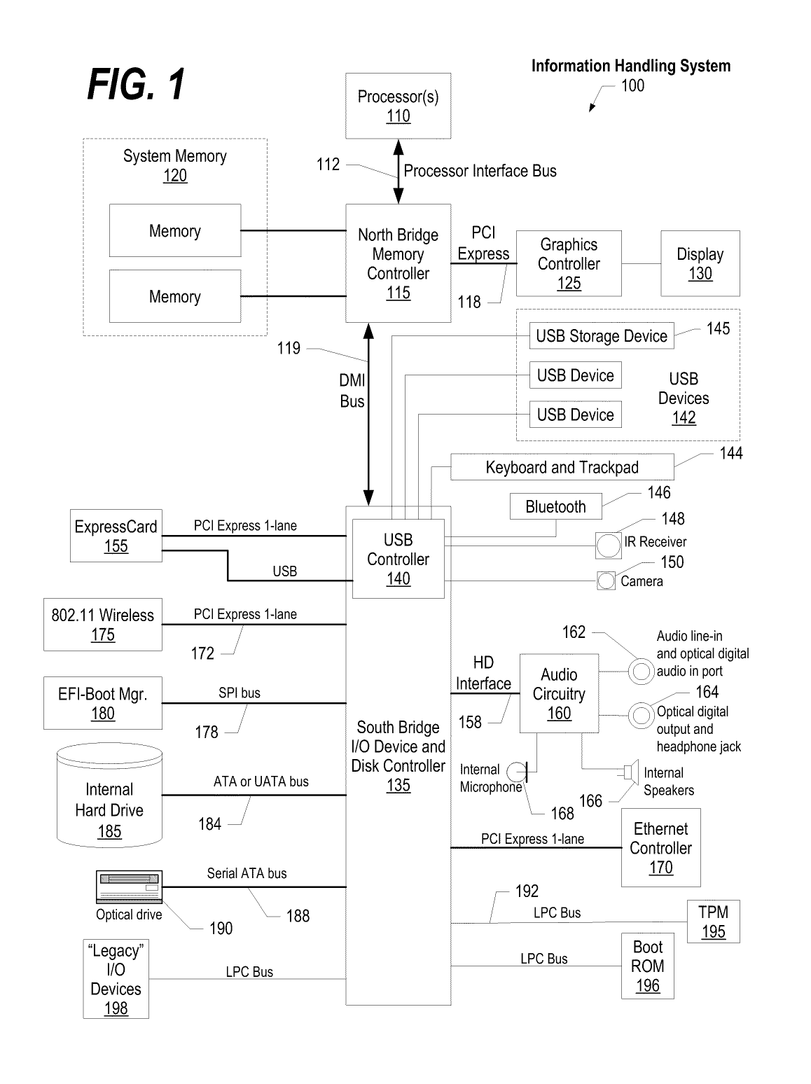

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

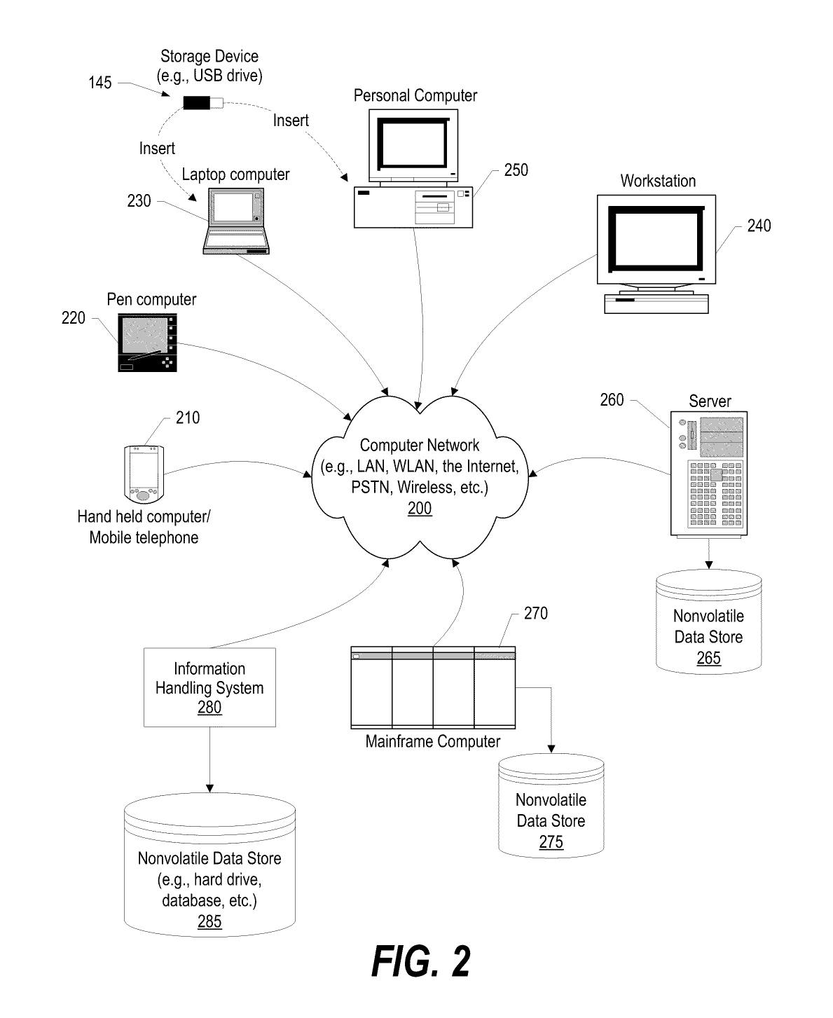

FIG. 2 is a network diagram of various types of data processing systems connected via a computer network. FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

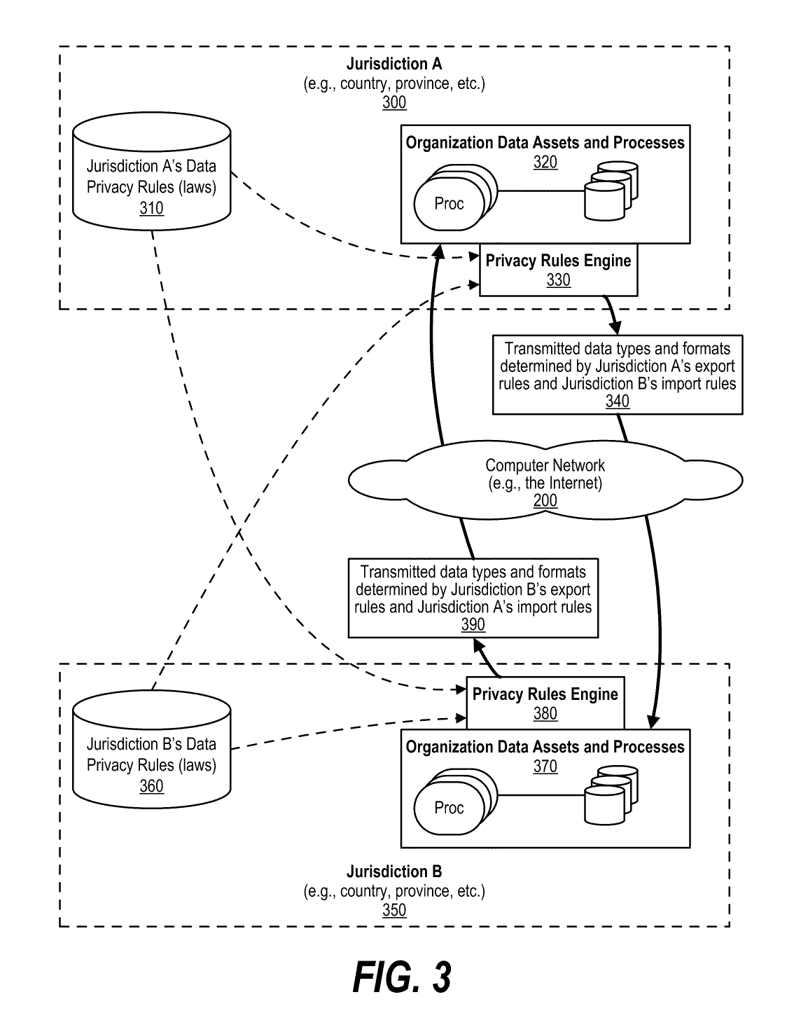

FIG. 3 is a diagram showing one implementation of privacy rules engines in order to comply with applicable privacy rules. FIG. 3 shows two entities exchanging data from two different jurisdictions with each jurisdiction potentially having different privacy rules governing the import or export of data. Jurisdiction A (300) is shown with data privacy rules 310, such as laws, which govern the import and/or export of data from/to Jurisdiction A. Organization data assets and processes 320 are organizational assets with software applications (processes) that retrieve and store data. Privacy rules engine 330 is a rules engine that aids in privacy compliance when data is being sent from Jurisdiction A to Jurisdiction B 350 so that transmitted data 340 includes data types and formats that are determined by Jurisdiction A's privacy export rules and/or Jurisdiction B's privacy import rules. Data formats includes formatting data elements using encryption technology so that the privacy of certain data elements is maintained. Privacy rules compliant data 340 is transmitted to Jurisdiction B via computer network 200.

Likewise, Jurisdiction B (350) is shown with data privacy rules 360, such as laws, which govern the import and/or export of data from/to Jurisdiction B. Organization data assets and processes 370 are organizational assets with software applications (processes) that retrieve and store data. Privacy rules engine 380 is a rules engine that aids in privacy compliance when data is being sent from Jurisdiction B to Jurisdiction A 300 so that transmitted data 390 includes data types and formats that are determined by Jurisdiction B's privacy export rules and/or Jurisdiction A's privacy import rules. Privacy rules compliant data 390 is transmitted to Jurisdiction B via computer network 200.

While FIG. 3 depicts two sets of organizational processes and rules engines, in one embodiment, such as that found in a Software as a Service (SaaS) environment, a single instance of the processes and rules engine is used to facilitate compliance with privacy rules. In such a single-instance embodiment, users would access the software application from different locations (e.g., via the Internet with users accessing the Internet from different geographical areas around the globe, etc.). The system would check privacy rules based on where individual users are located. The privacy rules engine would perform actions based on the import and export rules described above. These actions may include redacting (deleting) data that privacy rules prohibit from being transmitted from one jurisdiction (e.g., Jurisdiction A) to another jurisdiction (e.g., Jurisdiction B). As used herein, “jurisdictions” can be any geographical area, organization, or the like that enacts or issues privacy rules. Also, as used herein, “privacy rules” can include laws, such as those of a particular country or geopolitical organization, or organizational rules, such as those of a particular business or government organization. For example, one jurisdiction may enact a privacy rule that prohibits transmittal of individuals unique government identification numbers (e.g., social security numbers, etc.) while another jurisdiction may allow transmittal of such identification numbers so long as they are encrypted using an encryption algorithm of a particular strength.

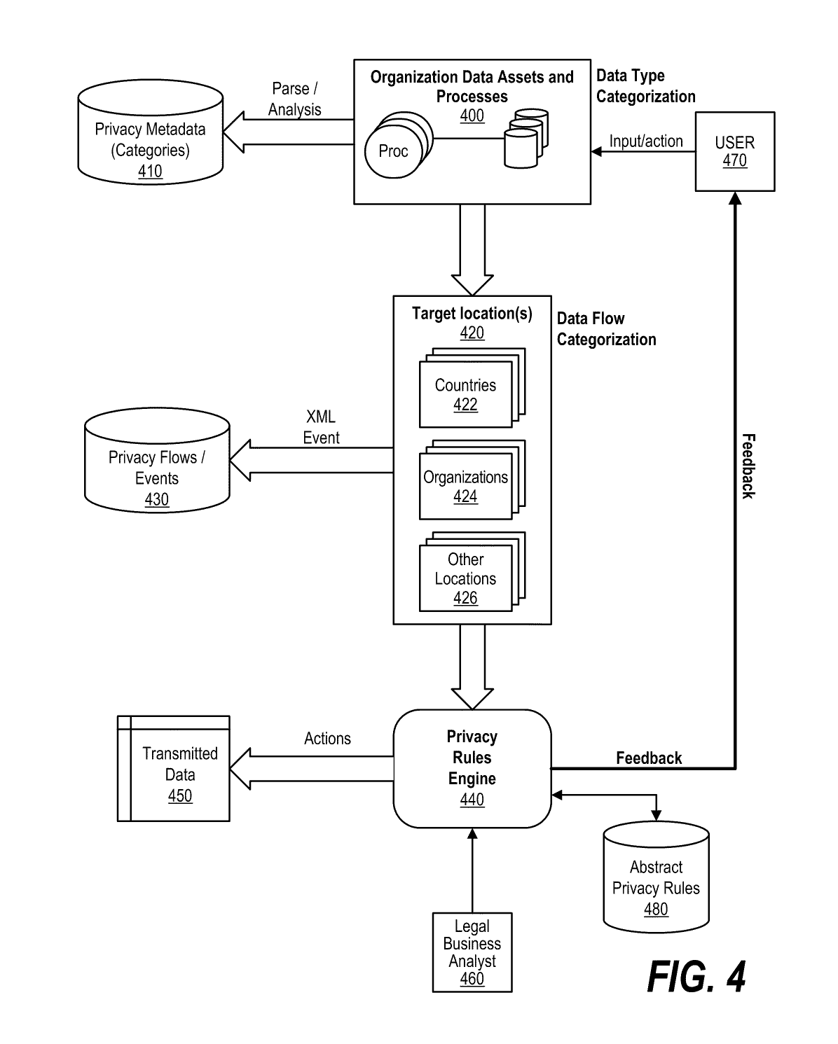

FIG. 4 is a diagram showing high level processes employed to categorize privacy data and data flows in order to detect privacy issues using a rules engine. User 470 is shown providing inputs and actions to organization data assets and processes 400. Data resulting from these processes is parsed and analyzed and stored in privacy metadata data store 410 which includes privacy data type categories corresponding to data elements included in organization data assets and processes 400. Data elements that have corresponding privacy data type categories assigned to them are identified. For example, if a data element is a government identification number (e.g., a social security number, etc.) that has a privacy data type category assigned, the corresponding privacy data type category would be identified. Data transactions are intended to be transmitted to a target location 420. Target locations include various types of locations such as countries 422, organizations (external or internal) 424, and other locations 426. The target location is identified (e.g., a particular country, etc.) which, in one embodiment, causes one or more XML events which are matched against records stored in privacy data flows data store 430. The data type categorization and the data flow categorization, resulting from the data elements being transmitted and the target location, respectively, are inputs to privacy rules engine 440. Based on the data type categorization and the data flow categorization, privacy rules engine 440 may take actions so that transmitted data 450 complies with applicable privacy rules. Privacy rules engine 440 also receives inputs from legal business analysts 460 which are stored as actions to take based upon the data elements being transmitted and the target locations. In one embodiment, these are stored as abstract privacy rules 480. In addition, privacy rules engine 440 provides feedback to user 470 when needed. For example, if the user is in a particular jurisdiction and is prohibited by a privacy rule from sending a particular data element to a user in another jurisdiction, the privacy rules engine would inform user 470 of the attempted privacy rules compliance breach so that the user can take alternative steps or refrain from sending the private data. In one embodiment, privacy rules engine 440 provides user 470 with an explanation of what data element cannot be sent to the target location along with a reason why the data cannot be sent. This explanation may help user 470 either understand the sensitivity and privacy of the data element and cause the user to refrain from sending the data element, or the explanation and reasons may aid the user in providing data to the target location in a manner that complies with applicable privacy rules. Actions privacy rules engine may take in sending transmitted data to the target location include encrypting certain data elements or redacting portions of data elements.

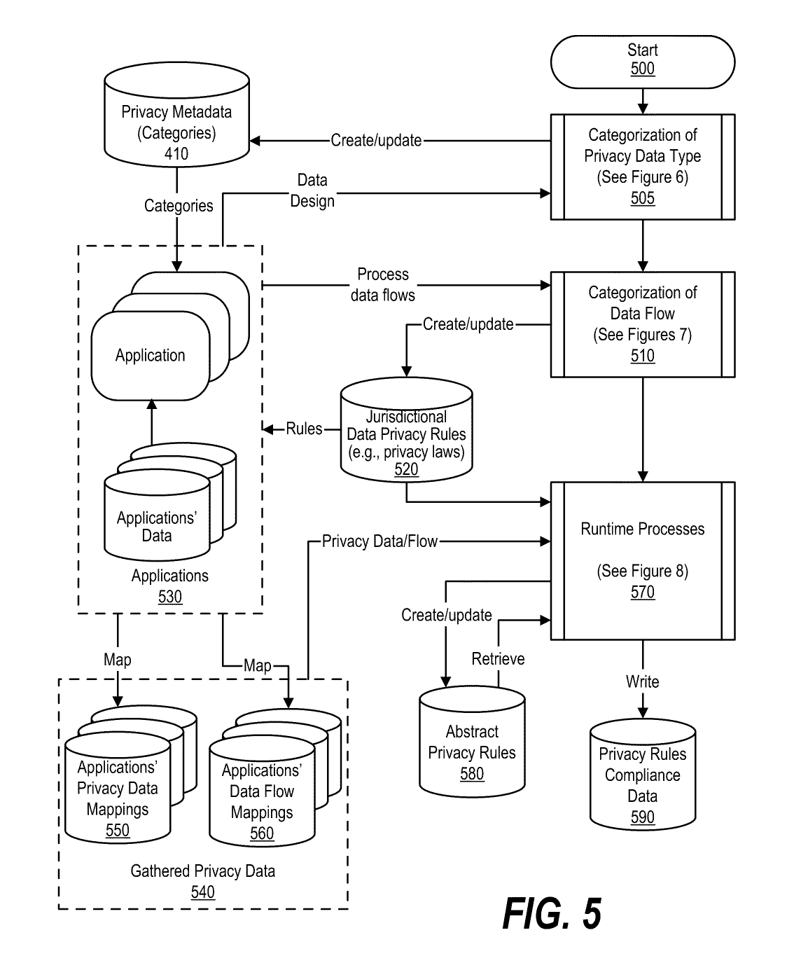

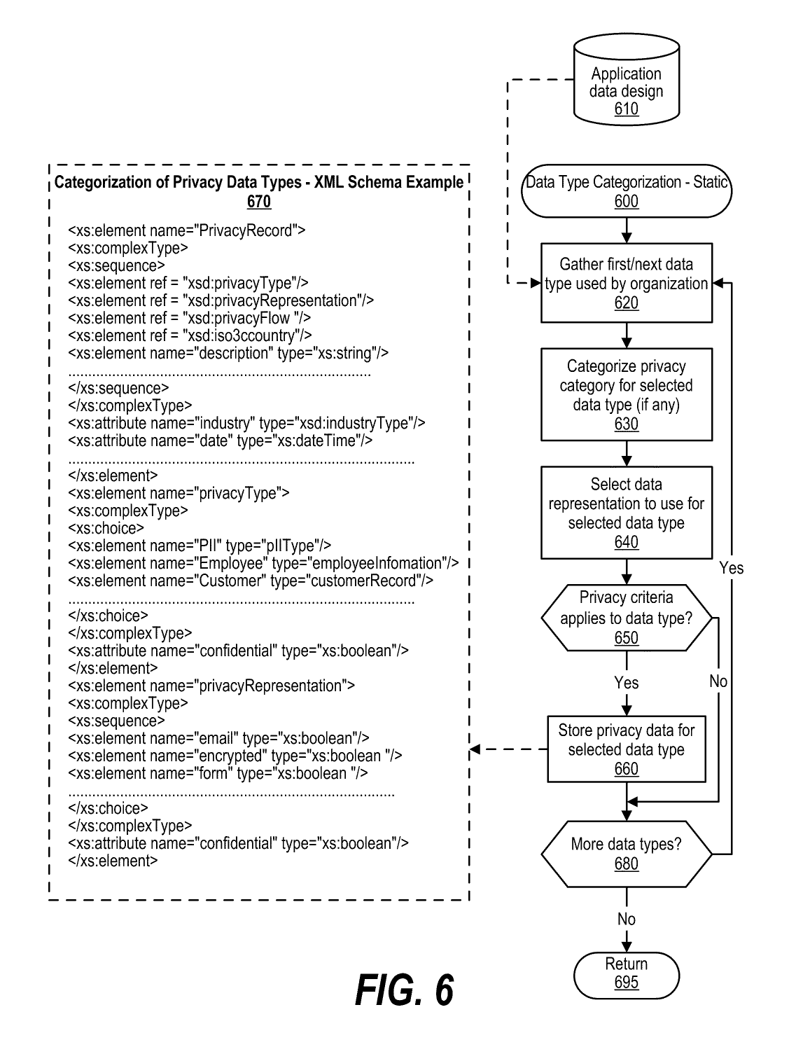

FIG. 5 is a high level flowchart showing processes performed and data gathered in order to execute the privacy rules engine. The process results in gathered privacy data 540 which includes applications' privacy data mappings 550 and applications' privacy data flow mappings 560. Processing commences at 500 whereupon, at predefined process 505, the system performs a categorization of privacy data types on data elements included in one or more software applications 530 (see FIG. 6 and corresponding text for processing details. The categorization of privacy data types creates and updates privacy metadata that is stored in privacy metadata data store 410. The categorization of privacy data types results in applications' privacy data mappings 550 which maps applications' data elements to privacy data type categories.

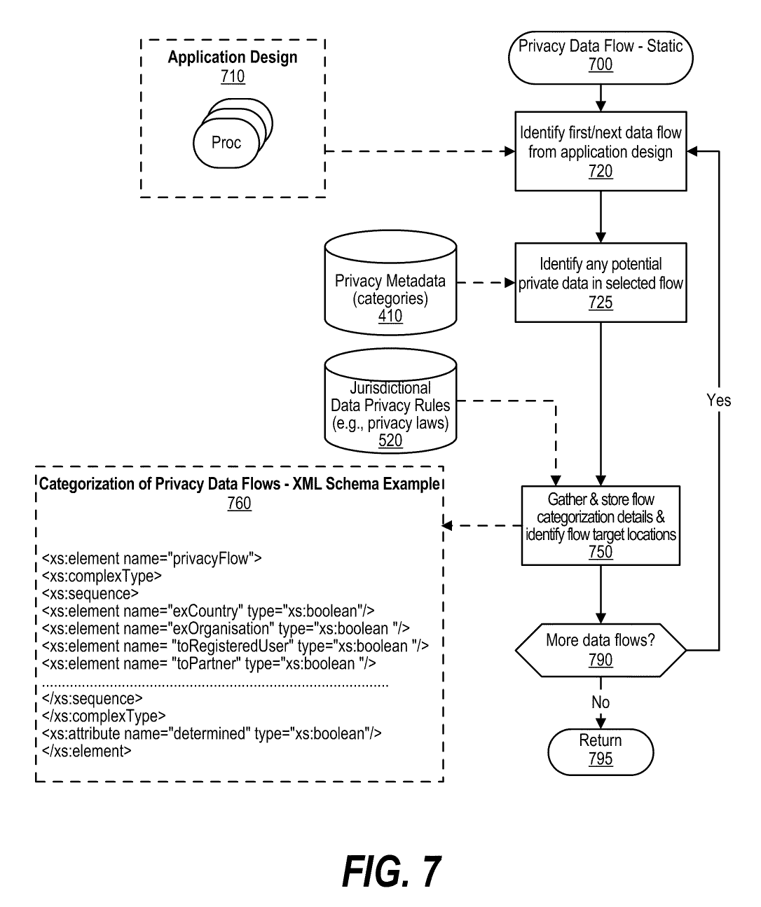

At predefined process 510, categorization of privacy data flows is performed using process data flows from applications 530 (see FIG. 7 and corresponding text for processing details). Various locations are stored in jurisdictional data privacy rules 520, such as privacy laws enacted by a particular country, geopolitical entity, privacy rules adopted by an organization, or the like. The result of predefined process 530 is applications' data flow mappings 560 which maps data flow categories and target locations. Predefined process 505 and 510 can be referred to as “static” or “design-time” activities as these processes are executed using the data design of software applications 530 and designed process flows of the processes included in applications 530.

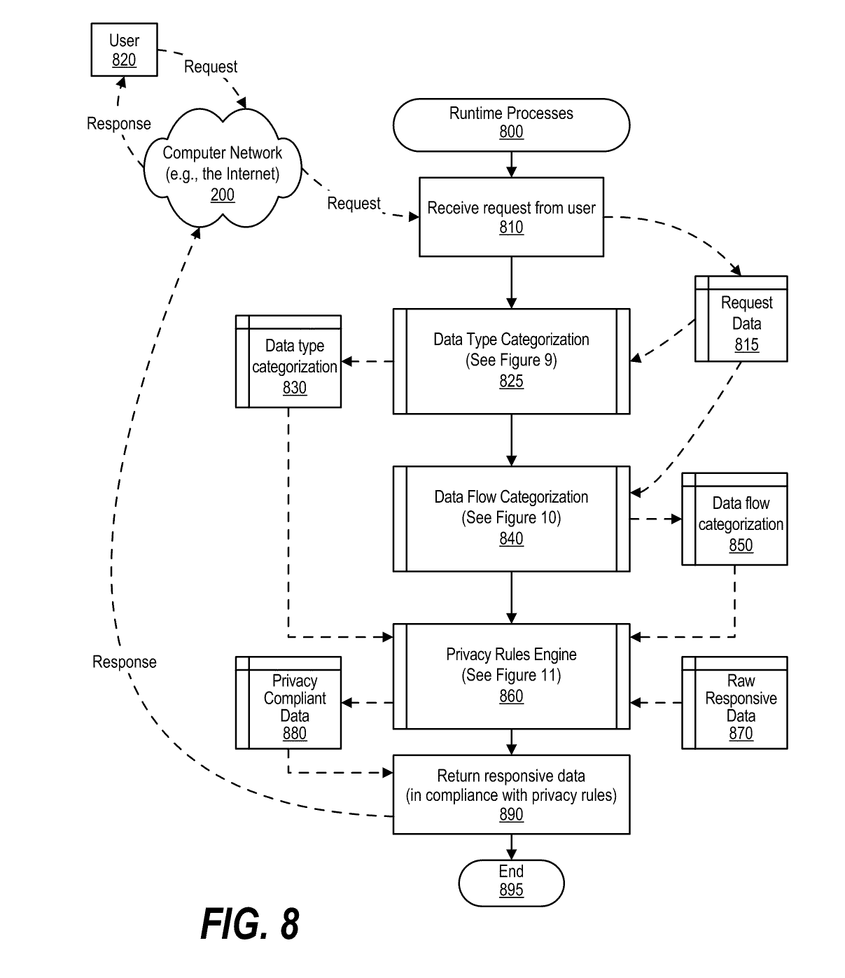

Runtime processes utilize gathered privacy data 540 and are shown as predefined process 570 (see FIG. 8 and corresponding text for processing details of runtime processes). Runtime processes maintain abstract privacy rules 580 which are utilized by a privacy rules engine to identify data privacy compliance issues using the privacy data mappings 550 and the data flow mappings 560 generated by the design-time processes. Runtime processes result in privacy rules compliance data 590 which includes information feedback provided to a user (e.g., when the user is attempting to send a data element to a target location with the data element/target location being in violation of a privacy rule included in data store 520). Privacy rules compliance data also includes modified data elements that have been modified by the runtime processes in order to comply with applicable privacy rules (e.g., encrypting a data element, redacting a portion of a data element, etc.).

FIG. 6 is an exemplary flowchart diagram showing the static (design time) categorization of privacy data types. Processing commences at 600 whereupon, at step 620, the process reads the first data type that is used in an application design (e.g., by reading application data design 610 or other data definition). At step 630, the selected data type is categorized according to its privacy type. In one embodiment, a user, such as a data analyst, categorizes some or all of the data types, while in another embodiment, a software process assigns a privacy data type category to the data type based on heuristics (e.g., evaluating data element names, etc.). At step 630, the analyst may need to create or extend XML schema 670 for any new data type categorization encountered in the software application that is being analyzed. In addition, the process or analyst decides how each piece of data included in application data design 610 maps to the data type categories included in XML schema 670. For example, if new functionality is being introduced in the application data design being analyzed for sharing activities related to employees, the analyst (or process) categorizes which XML element(s) these data elements (e.g., fields) map to in the XML schema. At step 640, a data representation is selected for the selected data type. One example of a data representation would be to encrypt the data element. Another example of a data representation would be to provide redaction criteria, for example, with a government issued identification number, deleting all digits except for the last four digits.

A decision is made as to whether privacy criteria applies to the selected data type (decision 650). If privacy criteria applies to the selected data type, then decision 650 branches to the “yes” branch whereupon, at step 660, the privacy data (privacy data type category and data representation information) are stored in categorization of privacy data types 670. In the embodiment shown, an XML schema is provided to store the privacy data. Some design data types may not have a privacy data type category or data representation, in which case decision 650 branches to the “no” branch bypassing step 660.

A decision is made as to whether there are more data types in the application data design to process (decision 680). If there are more data types to process, decision 680 branches to the “yes” branch which loops back to select and process the next data type from application data design 610. This looping continues until there are no more application data types to process, at which point decision 680 branches to the “no” branch and processing returns to the calling routine (see FIG. 5) at 695.

Category of privacy data is data that may breach a law depending on how it is used or depending on its destination. Examples might include employee data, telecommunication/financial customer records or “personally identifiable information” (“PII”) such as credit card details. Data representation is the format of the data when it is transmitted. Examples of data representation include encrypted data, email data, string type (ST), form, and HTML. In some cases, data representation is used to determine how the data should be processed. This could be represented in an XML schema like the following example:

```
<xs:element name=“PrivacyRecord”>
  <xs:complexType>
    <xs:sequence>
      <xs:element name “privacyType” type=“privacyType”/>
      <xs:element name “privacyRep ”
      type=“privacyRepresentation”/>
      <xs:element name “from Flow” type=“privacyFlow ”/>
      <xs:element name “toFlow” type=“privacyFlow ”/>
      <xs:element name “privacyType” type=“iso3ccountry”/>
      <xs:element name=“description” type=“xs:string”/>
............................................................................
    </xs:sequence>
  </xs:complexType>
      <xs:attribute name=“industry” type=“industryType”/>
      <xs:attribute name=“date” type=“xs:dateTime”/>
..................................................................................
</xs:element>
  <xs:element name=“privacyType”>
    <xs:complexType>
      <xs:choice>
      <xs:element name=“PII” type=“pIIType”/>
      <xs:element name=“Employee”
      type=“employeeInfomation”/>
      <xs:element name=“Customer” type=“customerRecord”/>
...................................................................................
    </xs:choice>
  </xs:complexType>
    <xs:attribute name=“confidential”
    type=“xs:boolean”/> </xs:element>
<xs:element name=“pIIType ”>
  <xs:complexType>
    <xs:sequence>
      <xs:element name=“name” type=“xs:boolean ”/>
      <xs:element name=“email” type=“xs:boolean”/>
      <xs:element name=“photo” type=“xs:boolean ”/>
      <xs:element name=“nationalIdentifier” type=“xs:boolean ”/>
      <xs:element name=“drivingLicenceId” type=“xs:boolean ”/>
      <xs:element name=“birthday” type=“xs:boolean ”/>
      <xs:element name=“ipAddress” type=“xs:boolean ”/>
...................................................................................
    </xs:choice>
  </xs:complexType>
</xs:element>
<xs:element name=“customerRecord ”>
  <xs:complexType>
    <xs:choice>
      <xs:element name=“industry” type=“industryType”/>
    <xs:element name=“description” type=“xs:String ”/>”
...................................................................................
    </xs:choice>
  </xs:complexType>
</xs:element>
<xs:element name=“industryType ”>
  <xs:complexType>
    <xs:choice>
      <xs:element name=“financial” type=“xs:boolean”/>
      <xs:element name=“telco” type=“xs:boolean”/>
      <xs:element name=“healthcare” type=“xs:boolean ”/>
    <xs:element name=“education” type=“xs:boolean ”/>
    <xs:element name=“public” type=“xs:boolean”/>
...................................................................................
    </xs:choice>
  </xs:complexType>
</xs:element>
<xs:element name=“privacyRepresentation”>
  <xs:complexType>
    <xs:sequence>
      <xs:element name=“email” type=“xs:boolean”/>
      <xs:element name=“encrypted” type=“xs:boolean ”/>
      <xs:element name=“form” type=“xs:boolean ”/>
      <xs:element name=“file” type=“xs:boolean ”/>
..................................................................................
    </xs:choice>
  </xs:complexType>
    <xs:attribute name=“confidential”
    type=“xs:boolean”/> </xs:element>
```

FIG. 7 is an exemplary flowchart diagram showing the static (design time) categorization of privacy data flows. Processing commences at 700 whereupon, at step 720, the process identifies the first data flow from application design 710 (e.g., by reading output statements in source code, by reading application design documents, etc.). At step 725, the process identifies any data that has potential privacy concerns by reading privacy metadata 410 that includes privacy data type categorizations.

At step 750, the process gathers and stores data flow category details based on the identified target locations. This data flow category details and identified target locations are stored in categorization of privacy data flows data store 760. In the embodiment shown, the categorization of privacy data flows is depicted as an XML schema.

A decision is made as to whether there are more data flows in the application design to process (decision 790). If there are more data flows to process, decision 790 branches to the “yes” branch which loops back to select and process the next data flow from application design 710. This looping continues until there are no more data flows to process, at which point decision 790 branches to the “no” branch and processing returns to the calling routine (see FIG. 5) at 795.

Categories of privacy data flow are created according to a criteria that is aligned to privacy laws or rules. The system detects whether the data is flowing outside a jurisdictional boundary, such as outside of an organization, outside of a country, or potentially to some “Denied Party List” (DPL) that is an unregistered user of the system. This could be represented in an XML schema like the following example:

```
<xs:element name=“privacyFlow”>
  <xs:complexType>
    <xs:sequence>
      <xs:element name=“exCountry” type=“xs:boolean”/>
      <xs:element name=“exEU” type=“xs:boolean”/>
      <xs:element name=“safeHarbourCountry”
      type=“xs:boolean”/>
      <xs:element name=“exOrganisation”
      type=“xs:boolean ”/>
      <xs:element name=“toRegisteredUser”
      type=“xs:boolean ”/>
      <xs:element name=“toPartner” type=“xs:boolean ”/>
......................................................................................
    </xs:sequence>
  </xs:complexType>
    <xs:attribute name=“determined” type=“xs:boolean”/>
    </xs:element>
```

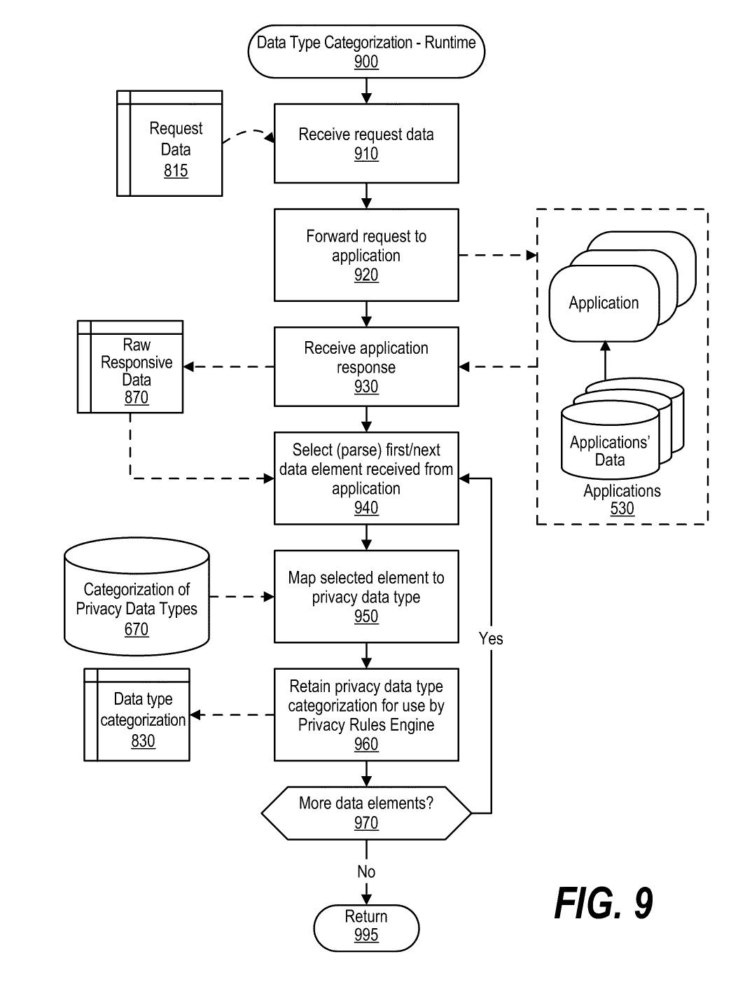

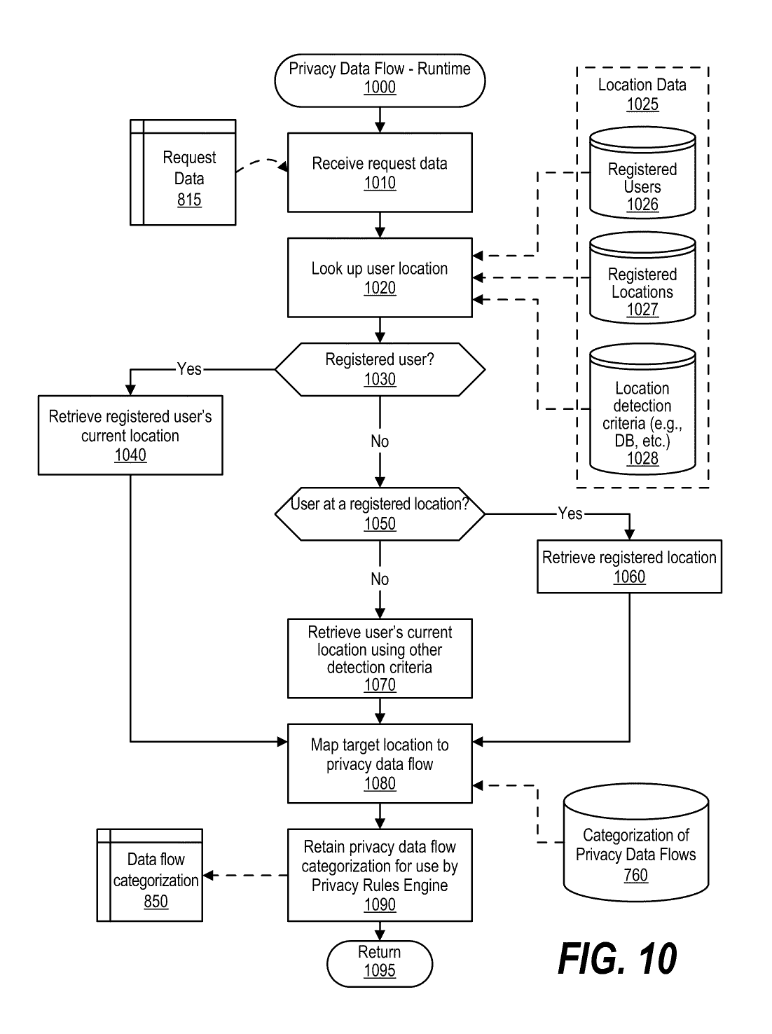

FIG. 8 is an exemplary flowchart diagram showing steps taken during runtime processing. Runtime processes are shown commencing at 800 whereupon, at step 810, the process receives a request from user 820 via computer network 200, such as the Internet. The request is stored in request data memory area 815. Data type categorization (predefined process 825) is performed using request data 815 as input and data type categorization data resulting from predefined process 825 are stored in memory 830. See FIG. 9 and corresponding text for processing details regarding data type categorization. Data flow categorization (predefined process 840) is also performed using request data with data flow categorization data resulting from predefined process 840 being stored in memory 850. See FIG. 10 and corresponding text for processing details regarding data flow categorization.

At predefined process 860, the privacy rules engine takes the data type categorization data and data flow categorization data as inputs along with the raw responsive data (870) resulting from the application software. The privacy rules engine creates privacy compliant data 880 and may also inform a user if data elements that the user intended to send to a target location violated any privacy rules. At step 890, the system returns privacy compliant data 880 to the user via computer network 200. Processing then ends at 895.

FIG. 9 is an exemplary flowchart diagram showing the dynamic (runtime) categorization of privacy data types. Processing commences at 900 whereupon, at step 910, the process receives request data 815 from the calling routine (see FIG. 8). At step 920, the process forwards the request to the software application (one of software applications 530) for processing. At step 930, the process receives responsive (“raw”) data from the software application. The responsive data is deemed raw as it may currently include data that breaches applicable privacy rules and needs to be acted upon (e.g., redacted, encrypted, etc.).

At step 940, the data type categorization process selects (parses) the first data element received from the software application. At step 950, the selected data element is mapped to a privacy data type category thus identifying a privacy data type category that corresponds to the selected data element. The mapping is performed by comparing the selected data type element to data store 670 that includes a categorization of privacy data types that was created during the static data type categorization process shown in FIG. 6. At step 960, the identified privacy data type category that corresponds to the selected data element is retained in memory area 830.

A decision is made as to whether there are more data elements received from the software application that need to be processed (decision 970). If there are more data elements to process, then decision 970 branches to the “yes” branch which loops back to select and process the next data element as described above. This looping continues until all of the data elements have been processed, at which point decision 970 branches to the “no” branch and processing returns to the calling routine (FIG. 8) at 995.

FIG. 10 is an exemplary flowchart diagram showing the dynamic (runtime) categorization of privacy data flows. Processing commences at 1000 whereupon, at step 1010, the process receives request data 815 from the calling routine (FIG. 8). At step 1020, the target location is determined by checking a variety of data stores where location data 1025 is maintained. These data stores include registered users data store 1026, registered locations data store 1027, and other location detection criteria data store 1028.

A decision is made (decision 1030) as to whether the target location is a registered user of the system that has registered his or her physical location (e.g., country, organization, etc.). If the target location is that of a registered user, then decision 1030 branches to the “yes” branch whereupon, at step 1040, the target location is identified based on the registered user's current location. On the other hand, if the target location does not include a registered user, then decision 1030 branches to the “no” branch whereupon a decision is made as to whether the user is at a registered location within the system (decision 1050). If the user is at a registered location (e.g., registered location data included in the request, etc.), then decision 1050 branches to the “yes” branch whereupon, at step 1060, the target location is retrieved from the registered location data. On the other hand, if the target location is not a registered location, then decision 1050 branches to the “no” branch whereupon, at step 1070, the target location is retrieved using other detection criteria, such as a database identifier that was accessed by the user, or other target data that indicates the target location.

At step 1080, the identified target location is mapped to a privacy data flow stored in categorization of privacy data flows 760. Categorization of privacy data flows was created during the static data flow categorization process shown in FIG. 7. At step 1090, the privacy data flow categorization identified in step 1080 is retained in memory area 850 for input to, and use by, the privacy rules engine. Processing thereafter returns to the calling routine (see FIG. 8) at 1095.

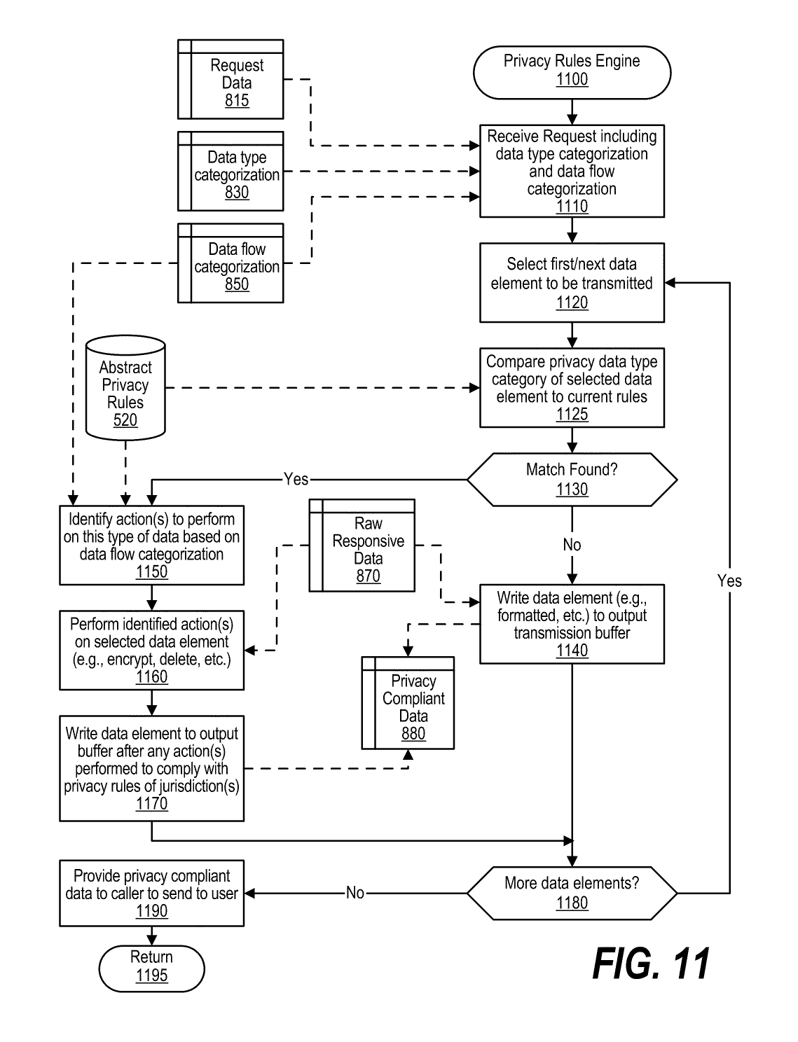

FIG. 11 is an exemplary flowchart diagram execution of the privacy rules engine to produce privacy compliant data. Processing commences at 1100 whereupon, at step 1110, the privacy rules engine receives request data 815, data type categorization 830 which was identified using the process shown in FIG. 9, and data flow categorization 850 which was identified using the process shown in FIG. 10. At step 1120 the first data element that is to be transmitted is selected. At step 1125, the privacy data type category of the selected data element is compared to the current data privacy rules stored in privacy rules data store 520. A decision is made as to whether a privacy rule matches the privacy data type category (decision 1130). If a privacy rule does not match the privacy data type category (e.g., no privacy rule applies to the selected data element's privacy data category), then decision 1130 branches to the “no” branch whereupon, at step 1140 the data element (raw data) is written to output transmission buffer 880 which stores privacy compliant data suitable for transmission to the target location.

On the other hand, if a privacy rule matches the privacy data type category of the selected data element, then decision 1130 branches to the “yes” branch whereupon, at step 1150, one or more actions to be performed on the selected data element are identified based on the data flow categorization which is based on the target location. At step 1160, the identified actions (e.g., encrypting the selected data element, redacting a portion of the selected data element, etc.) are performed on the selected data element. At step 1170, the resulting (modified) data element is written to output transmission buffer 880 which stores privacy compliant data suitable for transmission to the target location.

Before using the system in a production environment, test data can be used to identify potential privacy issues where data flows cross a jurisdictional boundary and where data flows potentially break jurisdictional privacy rules. In such a testing environment, the detection of these potential future privacy breaches can be used to redesign the system or the data flows to avoid or eliminate such potential privacy rule breaches. In a testing environment, the action performed could be to log the potential privacy rule breaches so that users, such as system developers and designers, can analyze the potential breaches and take remedial action by redesigning the data flows or the software application.

After the selected data element has been processed, a decision is made as to whether there are more data elements to process (decision 1180). If there are more data elements to process, then decision 1180 branches to the “yes” branch which loops back to select and process the next data element. This looping continues until all of the data elements have been processed, at which point decision 1180 branches to the “no” branch whereupon, at step 1190, the privacy compliant data (memory 880) is provided to the caller (see FIG. 8) for transmission to the target location. Processing thereafter returns to the calling routine (FIG. 8) at 1195.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive). Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

When multiple computer systems communicate with each other over a computer network, such as the Internet, each of the computer systems may be capable of executing the functional descriptive material that embodies the invention. In these environments, such as in a client-server environment or in a peer-to-peer environment, each of the computer systems includes computer storage media (e.g., memory, nonvolatile storage, etc.) capable of storing the functional descriptive material that embodies the invention. Functional descriptive material that implements the invention and is embodied on one of the computer storage media (e.g., on the server's computer storage media) can be transmitted (e.g., downloaded, etc.) from one of the computer systems (e.g., the server, one of the peers in a peer-to-peer network, etc.) to another of the computer system (e.g., the client, another of the peers in a peer-to-peer network, etc.). The functional descriptive material that embodies the invention can then be loaded and executed from the receiving computer system (e.g., from the client computer system, a receiving peer computer system in a peer-to-peer network, etc.).

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A processor-implemented method comprising:
receiving, at a source location, a request from a requestor, wherein the requestor is at a target location;
retrieving one or more data elements from a data store responsive to the request;
identifying a privacy data type category corresponding to one or more of the retrieved data elements;
identifying a data flow category based on the target location; and
performing one or more privacy actions modifying one or more of the data elements based on the privacy data type category of the data elements and the data flow category so that the modified data elements comply with one or more data privacy rules pertaining to the target location.

2. The method of claim 1 further comprising:
selecting a software application from a plurality of software applications, wherein the selected software application is based on the received request; and
sending the data request to the selected software application, wherein the software application retrieves the data elements from the data store.

3. The method of claim 1 wherein at least one of the privacy actions is an encryption action that encrypts one or more of the data elements in order to comply with the privacy rules.

4. The method of claim 1 wherein the identification of the data flow category further comprises:
identifying the target location of the requestor, wherein the identification of the target location comprises:
comparing request data included in the request with a plurality of registered user data records retrieved from a second data store.

5. The method of claim 1 further comprising:
searching a privacy rules data store for a combination of the privacy data type category corresponding to each of the data elements and the data flow category.

6. An information handling system comprising:
one or more processors;
a memory coupled to at least one of the processors;
a nonvolatile storage area that is accessible by at least one of the processors and that stores one or more data stores;
a network adapter that connects the information handling system to a computer network; and
a set of instructions stored in the memory and executed by at least one of the processors in order to perform actions of:
receiving, at the network adapter, a request from a requestor, wherein the requestor is at a target location;
retrieving one or more data elements from a data store responsive to the request;
identifying a privacy data type category corresponding to one or more of the retrieved data elements;
identifying a data flow category based on the target location; and
performing one or more privacy actions modifying one or more of the data elements based on the privacy data type category of the data elements and the data flow category so that the modified data elements comply with one or more data privacy rules pertaining to the target location.

7. The information handling system of claim 6 further comprising actions of:
selecting a software application from a plurality of software applications, wherein the selected software application is based on the received request; and
sending the data request to the selected software application, wherein the software application retrieves the data elements from the data store.

8. The information handling system of claim 6 wherein at least one of the privacy actions is an encryption action that encrypts one or more of the data elements in order to comply with the privacy rules.

9. The information handling system of claim 6 wherein the identification of the data flow category further comprises actions of:
identifying the target location of the requestor, wherein the identification of the target location comprises:
comparing request data included in the request with a plurality of registered user data records retrieved from a second data store.

10. The information handling system of claim 6 further comprising actions of:
searching a privacy rules data store for a combination of the privacy data type category corresponding to each of the data elements and the data flow category.

11. A computer program product stored in a computer readable medium, comprising functional descriptive material that, when executed by an information handling system, causes the information handling system to perform actions that include:
receiving, at a source location, a request from a requestor, wherein the requestor is at a target location;
retrieving one or more data elements from a data store responsive to the request;
identifying a privacy data type category corresponding to one or more of the retrieved data elements;
identifying a data flow category based on the target location; and
performing one or more privacy actions modifying one or more of the data elements based on the privacy data type category of the data elements and the data flow category so that the modified data elements comply with one or more data privacy rules pertaining to the target location.

12. The computer program product of claim 11 wherein the actions further comprise:
selecting a software application from a plurality of software applications, wherein the selected software application is based on the received request; and
sending the data request to the selected software application, wherein the software application retrieves the data elements from the data store.

13. The computer program product of claim 11 wherein at least one of the privacy actions is an encryption action that encrypts one or more of the data elements in order to comply with the privacy rules.

14. The computer program product of claim 11 wherein the identification of the data flow category includes further actions comprising:
identifying the target location of the requestor, wherein the identification of the target location comprises:
comparing request data included in the request with a plurality of registered user data records retrieved from a second data store.

15. The computer program product of claim 11 wherein the actions further comprise:
searching a privacy rules data store for a combination of the privacy data type category corresponding to each of the data elements and the data flow category.

16. The computer program product of claim 11 wherein the functional descriptive material are stored in a computer readable storage medium in an information handling system, and wherein the functional descriptive material was downloaded over a computer network from a remote information handling system.

17. The computer program product of claim 11 wherein the functional descriptive material are stored in a first computer readable storage medium in a server information handling system, and wherein the functional descriptive material is downloaded over a computer network to a remote information handling system for use in a second computer readable storage medium with the remote information handling system.

18. A processor-implemented method comprising:
retrieving a plurality of data types included in a data design of a software application;
selecting one or more privacy categories wherein each of the selected privacy categories correspond to one or more of the plurality of retrieved data types;
retrieving flow categorization data corresponding to one or more processes included in the software application;
comparing the selected privacy categories and the retrieved flow categorization data to one or more privacy rules; and
informing a user when the comparison reveals that one or more of the privacy rules is violated to facilitate modification of the software application in order to comply with the privacy rules.

19. The method of claim 18 further comprising:
storing the selected privacy categories in a first data store; and
storing the retrieved flow categorization data in a second data store.

20. The method of claim 19 further comprising:
selecting a data representation corresponding to at least one of the data types; and
storing the selected data representation in the first data store.

21. The method of claim 20 wherein one of the selected data representations is an encryption representation used to encrypt a corresponding data element prior to transmitting the data element to a target location.

22. The method of claim 18 further comprising:
receiving an action corresponding to one of the selected privacy categories and one of the retrieved flow categorization data so that the action is performed when a responsive data element matches the one selected privacy category and a target location matches the retrieved flow categorization data; and
storing the action in a data store.

23. A computer program product stored in a computer readable medium, comprising functional descriptive material that, when executed by an information handling system, causes the information handling system to perform actions that include:
retrieving a plurality of data types included in a data design of a software application;
selecting one or more privacy categories wherein each of the selected privacy categories correspond to one or more of the plurality of retrieved data types;
retrieving flow categorization data corresponding to one or more processes included in the software application;
comparing the selected privacy categories and the retrieved flow categorization data to one or more privacy rules; and
informing a user when the comparison reveals that one or more of the privacy rules is violated to facilitate modification of the software application in order to comply with the privacy rules.

24. The computer program product of claim 23 further comprising:
storing the selected privacy categories in a first data store; and
storing the retrieved flow categorization data in a second data store.

25. The computer program product of claim 24 further comprising:
selecting a data representation corresponding to at least one of the data types; and
storing the selected data representation in the first data store.

26. The computer program product of claim 25 wherein one of the selected data representations is an encryption representation used to encrypt a corresponding data element prior to transmitting the data element to a target location.

27. The computer program product of claim 23 further comprising:
receiving an action corresponding to one of the selected privacy categories and one of the retrieved flow categorization data so that the action is performed when a responsive data element matches the one selected privacy category and a target location matches the retrieved flow categorization data; and
storing the action in a data store.

28. The computer program product of claim 23 wherein the functional descriptive material are stored in a computer readable storage medium in an information handling system, and wherein the functional descriptive material was downloaded over a computer network from a remote information handling system.

29. The computer program product of claim 23 wherein the functional descriptive material are stored in a first computer readable storage medium in a server information handling system, and wherein the functional descriptive material is downloaded over a computer network to a remote information handling system for use in a second computer readable storage medium with the remote information handling system.
